(19) United States
(12) Patent Application Publication
(10) Pub. No.: US 2005/0188102 A1
(43) Pub. Date: Aug. 25, 2005

(54) Scheduling packet processing

(76) Inventor: Tomasz Bogdan Madajczak, Pomorskie (PL)

Correspondence Address: FISH & RICHARDSON, PC, 12390 EL CAMINO REAL, SAN DIEGO, CA, 92130-2081, US

(21) Appl. No.: 10/748,705

(22) Filed: Dec. 29, 2003

(51) Int. Cl. G06F 15/173

(52) U.S. Cl. 709/238

(57) ABSTRACT

A method includes scheduling processing of a packet received by a packet processor with a hardware scheduler in a stack processor included in the packet processor.

### BACKGROUND

Networks are used to distribute information among computer systems by sending the information in segments such as packets. A packet includes a “header” that includes routing information used to direct the packet through the network to a destination. The packet also includes a “payload” that stores a portion of information being sent through the network. To exchange packets, the computer systems located at network locations recognize and observe a set of packet transferring rules known as a protocol. For example, the transmission control protocol/internet protocol (TCP/IP) is typically used for exchanging packets over the Internet. By subscribing to a two-layer protocol such as TCP/IP, rules are provided by TCP for assembling the packets for transmission and reassembling after reception. Furthermore, the lower layer IP handles addresses associated with each packet for delivering at the appropriate destination.

### DESCRIPTION OF DRAWINGS

FIG. 1 is a block diagram depicting a system for processing packets.

FIG. 2 is a block diagram depicting a network processor.

FIG. 3 is a block diagram depicting a portion of a network processor.

FIG. 4 is a block diagram depicting a scheduler implemented in a stack processor.

FIG. 5 is a flow chart of a portion of a scheduler.

### DESCRIPTION

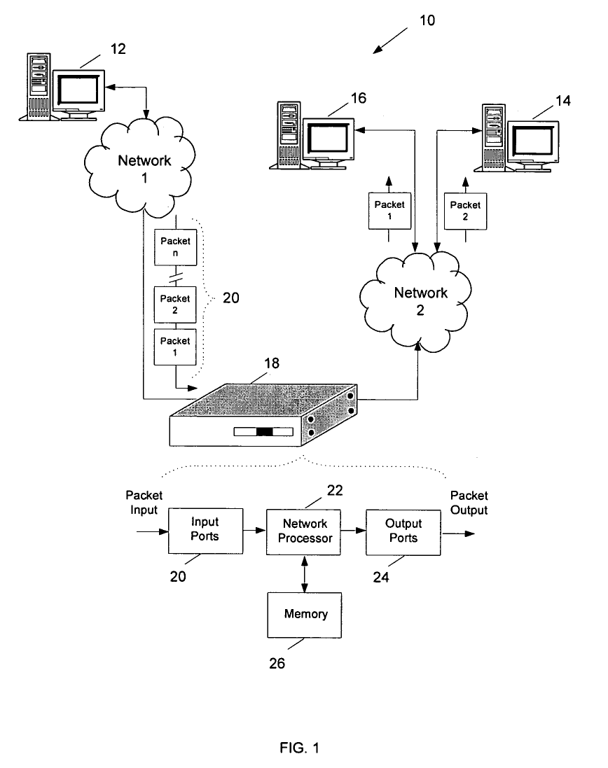

Referring to FIG. 1, a system 10 for transmitting packets from a computer system 12 through a network_1 (e.g., a local area network (LAN), a wide area network (WAN), the Internet, etc.) to other computer systems 14, 16 by way of another network_2 includes a router 18 that collects a stream of “n” packets 20 and schedules delivery of the individual packets to the appropriate destinations as provided by information included in the packets. For example, information stored in the “header” of packet_1 is used by the router 18 to send the packet through network_2 to computer system 16 while “header” information in packet_2 is used to send packet_2 to computer system 14.

Typically, the packets are received by the router 18 on one or more input ports 20 that provide a physical link to network_1. The input ports 20 are in communication with a network processor 22 that controls reception of incoming packets. However, in some arrangements the system 10 uses other packet processor designs. The network processor 22 also communicates with router output ports 24 that are used for scheduling transmission of the packets through network_2 for delivery at one or more appropriate destinations, e.g., computer systems 14, 16. In this particular example, the router 18 uses the network processor 22 to deliver a stream of “n” packets 20, however, in other arrangements a hub, switch, or other similar packet forwarding device that includes a network processor is used to transmit the packets.

Typically, as the packets are received, the router 18 stores the packets in a memory 26 (e.g., a dynamic random access memory (DRAM), etc.) that is in communication with the network processor 22. By storing the packets in the memory 26, the network processor 22 can access the memory to retrieve one or more packets, for example, to verify if a packet has been lost in transmission through network_1, or to determine a packet destination, or to perform other processing such as encapsulating a packet to add header information associated with a protocol layer.

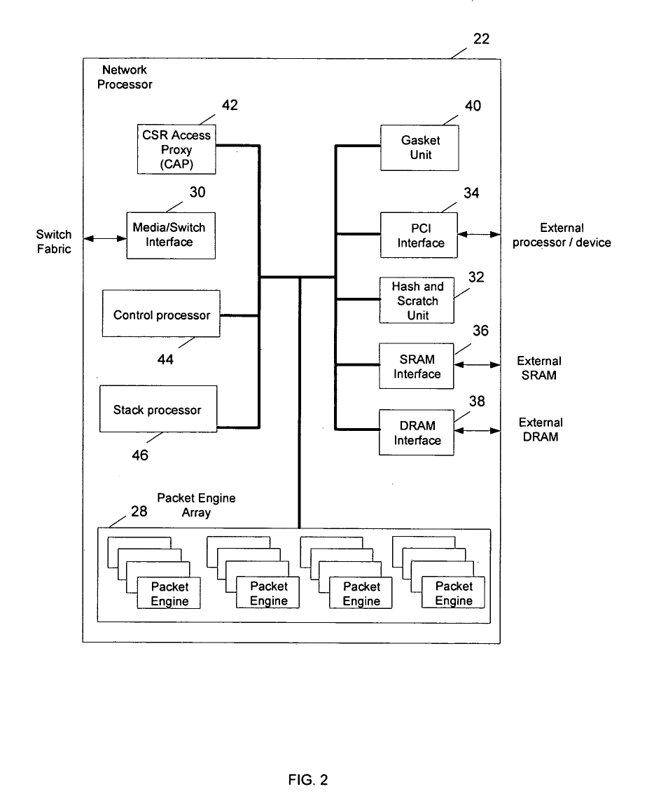

Referring to FIG. 2, the network processor 22 is depicted to include features of an Intel® Internet exchange network processor (IXP). However, in some arrangements the network processor 22 incorporates other processor designs for processing packets. This exemplary network processor 22 includes an array of sixteen packet engines 28 with each engine providing multi-threading capability for executing instructions from an instruction set such as a reduced instruction set computing (RISC) architecture.

Each packet engine included in the array 28 also includes, e.g., eight threads that interleave instruction execution so that multiple instruction streams execute efficiently and make more productive use of the packet engine resources that might otherwise be idle. In some arrangements, the multi-threading capability of the packet engine array 28 is supported by hardware that reserves different registers for different threads and quickly swaps thread contexts. In addition to accessing shared memory, each packet engine also features local memory and a content-addressable memory (CAM). The packet engines may communicate among each other, for example, by using neighbor registers in communication with an adjacent engine or by using shared memory space.

The network processor 22 also includes interfaces for passing data with devices external or internal to the processor. For example, the network processor 22 includes a media/switch interface 30 (e.g., a CSIX interface) that sends data to and receives data from devices connected to the network processor such as physical or link layer devices, a switch fabric, or other processors or circuitry. A hash and scratch unit 32 is also included in the network processor 22. The hash function provides, for example, the capability to perform polynomial division (e.g., 48-bit, 64-bit, 128-bit, etc.) in hardware that conserves additional clock cycles typically needed in a software-implemented hash function. The hash and scratch unit 32 also includes memory such as static random access memory (SRAM) that provides a scratchpad function while operating relatively quickly compared to SRAM external to the network processor 22.

The network processor 22 also includes a peripheral component interconnect (PCI) interface 34 for communicating with another processor such as a microprocessor (e.g. Intel Pentium®, etc.) or to provide an interface to an external device such as a public-key cryptosystem (e.g., a public-key accelerator). The PCI interface 34 also transfers data to and from the network processor 22 and to external memory (e.g., SRAM, DRAM, etc.) that is in communication with the network processor.

The network processor 22 includes an SRAM interface 36 that controls read and write accesses to external SRAMs along with modified read/write operations (e.g., increment, decrement, add, subtract, bit-set, bit-clear, swap, etc.), link-list queue operations, and circular buffer operations. A DRAM interface 38 controls DRAM external to the network processor 22, such as memory 26, by providing hardware interleaving of DRAM address space to prevent extensive use of particular portions of memory. The network processor 22 also includes a gasket unit 40 that provides additional interface circuitry and a control and status registers (CSR) access proxy (CAP) 42 that includes registers for signaling one or more threads included in the packet engines.

Typically, the packet engines in the array 28 execute “data plane” operations that include processing and forwarding received packets. Some received packets, which are known as exception packets, need processing beyond the operations executed by the packet engines. Additionally, operations associated with management tasks (e.g., gathering and reporting statistics, etc.) and control tasks (e.g., look-up table maintenance, etc.) are typically not executed on the packet engine array 28.

To perform management and control tasks, the network processor 22 includes a control processor 44 and a stack processor 46 for executing these “slower path” operations. In this arrangement, both of the control and stack processors 44, 46 include Intel XScale™ core processors that are typically 32-bit general purpose RISC processors. The control and stack processors 44, 46 also include an instruction cache and a data cache. In this arrangement the control processor 44 also manages the operations of the packet engine array 28.

The stack processor 46 schedules and executes tasks associated with protocol stacks duties (e.g., TCP/IP operations, UDP/IP operations, packet traffic termination, etc.) related to some of the received packets. In general, a protocol stack is a layered set of data formatting and transmission rules (e.g., protocols) that work together to provide a set of network functions. For example the open source initiative (OSI) promotes a seven-layer protocol stack model. By layering the protocols in a stack, an intermediate protocol layer typically uses the layer below it to provide a service to the layer above.

By separating the execution of the control tasks and the stack tasks between the control processor 44 and the stack processor 46, the network processor 22 can execute the respective tasks in parallel and increase packet processing rates to levels needed in some applications. For example, in telecommunication applications, bursts of packets are typically received by the network processor 22. By dividing particular tasks between the processors 44, 46, the network processor 22 has increased agility to receive and process the packet bursts and reduce the probability of losing one or more of the packets. Additionally, since both processors 44, 46 execute instructions in parallel, clock cycles are conserved and may be used to execute other tasks on the network processor 22.

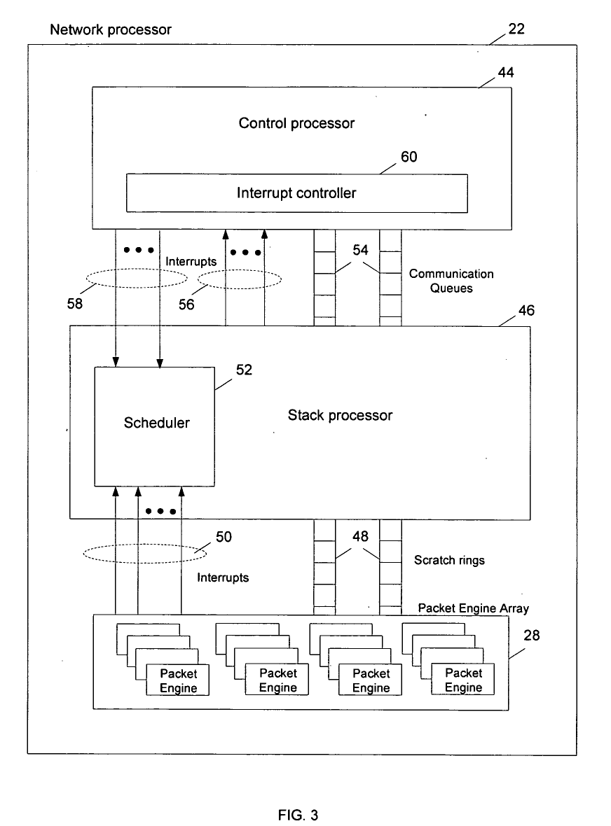

Referring to FIG. 3, the packet engine array 28, the stack processor 46, and the control processor 44 operate together on the network processor 22. For example, some received packets are passed from the packet engines to the stack processor 46 for re-assembling the data stored in the packets into a message that is passed from the stack processor to the control processor 44. In another example, if the packet engines cannot determine a destination for a particular packet, known as an exception packet, the packet is sent to the stack processor 44 for determining the destination. In another exemplary operation, the stack processor 46 receives a packet from the packet engine array 28 to encapsulate the packet with another protocol (e.g., TCP) layer. Typically, to encapsulate the received packet, the stack processor 46 adds additional header information to the packet that is related to a particular protocol layer (e.g., network layer, transport layer, application layer etc.).

To send a packet to the stack processor 46, one of the packet engines stores the packet in a scratch ring 48 that is accessible by the stack processor. In this example the network processor 22 includes more than one scratch ring for passing packets to the stack processor 46. Also, while this example uses scratch rings 48 for passing packets, in other arrangements other data storage devices (e.g., buffers) are used for transferring packets. In addition to passing received packets, the packet engine array 28 sends one or more interrupts 50, or other similar signals, to the stack processor 46 for notification that one or more of the packet engines are ready for transferring packets or other data. In some arrangements, each time a packet is stored in one of the scratch rings 48, an interrupt is sent to the stack processor 46.

Since multiple interrupts 50 can be received from multiple packet engines during a time period, the stack processor 46 includes a scheduler 52 for scheduling the retrieval and processing of packets placed in the scratch rings 48. In this example, the scheduler 52 is hardware-implemented in the stack processor so that scheduling tasks are executed relatively quickly. However, in other examples the scheduler 52 is implemented by the stack processor 46 executing code instructions that are stored in a storage device (e.g., hard drive, CD-ROM, etc.) or other type of memory (e.g., RAM, ROM, SRAM, DRAM, etc.) in communication with the stack processor.

In this example, the hardware-implemented scheduler 52 executes operations using the interrupts 50 to schedule processing of the packets in the scratch rings 48. Upon receiving an interrupt signal, the scheduler 52 determines if the interrupt is to be given a high priority and packets associated with the interrupt are to be processed relatively quickly, or if the interrupt should be given low priority and processing of the associated packets can be delayed. Typically, to determine an interrupt priority, the scheduler 52 uses a set of predefined rules that are stored in a memory that is typically included in the stack processor 46. The scheduler 52 also controls timing and manages clock signals used by the stack processor 46.

After assigning a priority to the packet associated with a received interrupt, at an appropriate time the packet is retrieved from the scratch ring 48 by the stack processor 46 and the scheduled packet processing is executed. In one example of processing, the stack processor 46 converts a packet for use with the address resolution protocol (ARP), which is a protocol for mapping an Internet Protocol (IP) address to a physical machine address that is recognized in a local network. In another example, the stack processor 46 converts an address that is included in a packet and is 32-bit in length, into a 48-bit media access control (MAC) address that is typically used in an Ethernet local area network. To perform such a conversion, a table, usually called the ARP cache, is used to look-up a MAC address from the IP address or vice versa. Furthermore, the stack processor 46 may perform operations on a packet that are related to other protocols such as the user datagram protocol (UDP), the Internet control message protocol (ICMP), which is a message control and error-reporting protocol, or other protocols.

The stack processor 46 combines segmented data from a group of retrieved packets to re-assemble the data into a single message. For example, in some applications the stack processor combines segments that include audio content of a packet-based voice traffic system such as voice-over-IP (VoIP). In another example the stack processor 46 combines segments that include video content to produce a message that includes a stream of video. By having the stack processor 46 dedicated to performing such stack duties, the processing burden of the control processor 44 is reduced and clock cycles can be used to perform other tasks in parallel.

The stack processor 46 sends the message of the combined segmented packet data to the control processor 44. To pass data between the control processor 44 and the stack processor 46, the network processor 22 includes communication queues 54 that provide a communication link between tasks being executed on two processors. In some arrangements, the communication queues are socket queues that operate with associated processes executed in the network processor 22. In other arrangements the communication queues 54 use other queuing technology such as first-in-first-out (FIFO) queues, rings such as scratch rings, or other individual or combinations of data storing devices. The network processor 22 includes multiple communication queues 54 for delivering data to the control processor. Additionally, the control processor 44 and the stack processor 56 send interrupts for signaling each other. When a message is placed into one or more of the communication queues 54, one or more interrupts 56 are sent from the stack processor 46 to the control processor 44. The scheduler 52 receives interrupts 58 from the control processor 44 for signaling when the control processor 44 is, e.g., sending a message to or retrieving a message from one or more of the communication queues 54. In some arrangements the control processor includes an interrupt controller 60 for managing received and sent interrupts.

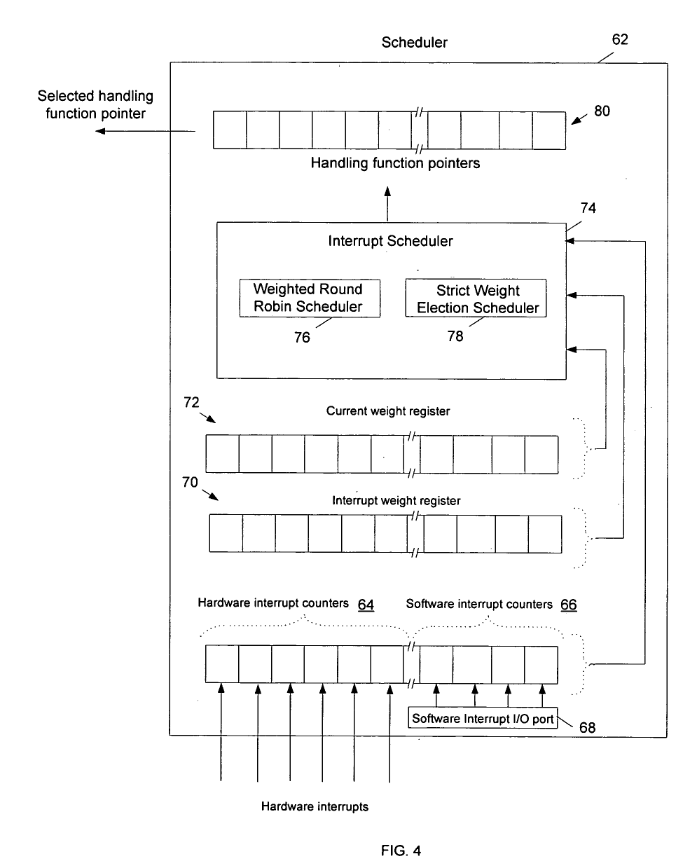

Referring to FIG. 4, an exemplary scheduler 62 is implemented in the hardware of the stack processor 46 such as scheduler 52. The scheduler 62 includes counters 64, 66 that receive interrupts from hardware sources (e.g., the packet engine array 28, etc.) and from software sources that are received though a software interrupt I/O port 68 and stored in the respective hardware-implemented counters 66. By storing both types of interrupts in hardware, the scheduler 62 processes the interrupts relatively quickly. As each type of interrupt is received, the respective counter associated with the interrupt counts the number of occurrences of the interrupt. Additionally, when the scheduler 62 determines to execute a task to handle a particular interrupt, the respective counter is decremented to represent the execution.

In addition to counting each received interrupt, the scheduler 62 includes registers 70, 72 that store data that represents weight values to be respectively used with the interrupt counts stored in the counters 64, 66. For example, interrupts with higher priority are typically assigned a larger weight value than lower priority interrupts. The interrupt weight register 70 stores initial weights that have values dependent upon the function of the router 18 (e.g., an edge router, a core router, etc.) and on an allowable degree of router services (e.g., allowable probability of packet loss). The current weight register 72 also stores values that are associated with each interrupt received by the scheduler 62 and that may or may not be used with the initial weight values depending upon the scheduling scheme being executed by the scheduler.

The data stored in the interrupt counters 64, 66 and the weight registers 70, 72 are accessible by an interrupt scheduler 74 that is included in the scheduler 62. The interrupt scheduler 74 uses the data to evaluate the received interrupts and determine the order for handling each interrupt. In this example the interrupt scheduler 74 includes two selectable hardware-implemented scheduling schemes, however, in other arrangements the interrupt scheduler includes more or less scheduling schemes. A weighted round robin scheduler 76 uses the data stored in the interrupt counters 64, 66 and the interrupt weight register 70 to determine the order for handling the received interrupts.

A strict weight election scheduler 78 uses the data stored in the interrupt counters 64, 66 and the data stored in the current weight register 72 to determine the handling order of the interrupts. In general, the strict weight election scheduler 78 compares the summation of interrupt counts with corresponding current weights to determine the interrupt handling order. Since the counters 64, 66 and the registers 70, 72 are hardware implemented, either of the scheduling schemes 76, 78 can quickly access the stored data without copying the data to one or more registers dedicated to the interrupt scheduler 74.

In some arrangements the weighted round robin scheduler 76 evaluates the interrupts by cycling through the data stored in the interrupt counters 64, 66 to determine if one or more particular interrupts have been received. If the scheduler 76 determines that at least one particular type of interrupt has been received, the scheduler identifies a particular handling function to be executed by the stack processor 46. Alternatively, if the strict weight election scheduler 78 is selected to order interrupt handling, the counter registers 64, 66 and the current weight register 72 are accessed for respectively stored data. In some arrangements the strict weight election scheduler 78 includes a hardware-implemented comparator tree that compares respective summations of the current weights and interrupt counts. Based on the comparison, and similar to the weighted round robin scheduler 76, the strict weight election scheduler 78 identifies a particular function for handling the next scheduled interrupt.

After the interrupt handling function is identified, the interrupt scheduler 74 selects a handling function pointer from a register 80 that stores a group of pointers for handling a variety of interrupts. Once a particular pointer has been selected the scheduler provides the pointer to the stack processor 46 for executing a function or routine associated with the pointer. However, in other arrangements the scheduler 62 provides the network processor 46 with a filename or other type of indicator for executing the selected interrupt handling function or routine.

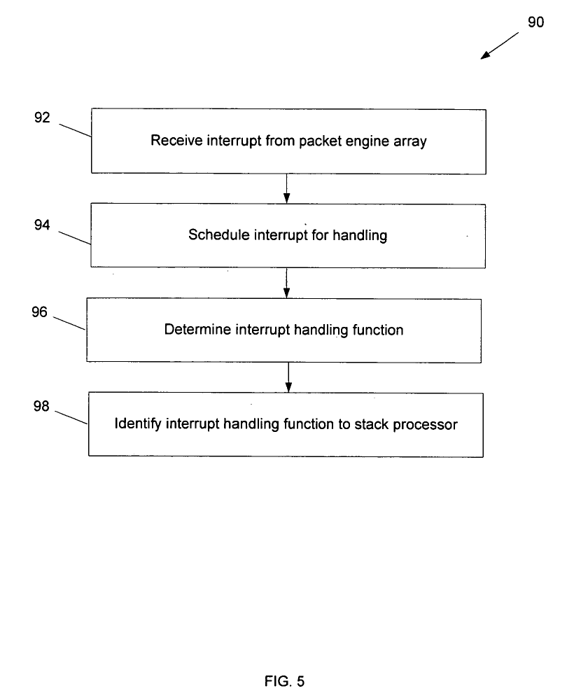

Referring to FIG. 5, an example of a portion of a scheduler 90, such as scheduler 62, which is implemented in the stack processor 46 includes receiving 92 an interrupt from a packet engine included in the array 28. After the interrupt is received, the scheduler 90 schedules 94 the interrupt for handling by the stack processor. For example, the scheduler 90 counts the received interrupt with previous occurrences of the interrupt and uses a weighted round robin scheduler, a strict weight election scheduler, or other scheduling scheme to determine an appropriate time to handle the received interrupt. Typically, the received interrupt is scheduled for immediate handling or for handling in the near future. After the interrupt is scheduled 94 and at the appropriately scheduled time, the scheduler 90 determines 96 the function or routine to handle the received interrupt and identifies 98 the interrupt handling function to the stack processor 46 for execution. In one example, the scheduler 90 selects a pointer associated with the interrupt handling function or routine and provides the pointer to the stack processor 46.

Particular embodiments have been described, however other embodiments are within the scope of the following claims. For example, the operations of the scheduler 90 can be performed in a different order and still achieve desirable results.

1. A method comprising:
scheduling processing of a packet received by a packet processor with a hardware scheduler in a stack processor included in the packet processor.

2. The method of claim 1 wherein the scheduling includes receiving an interrupt signal from a packet engine included in the packet processor.

3. The method of claim 1 wherein the scheduling includes identifying an interrupt handling routine.

4. The method of claim 2 wherein a control processor in the packet processor manages the packet engine.

5. The method of claim 1 wherein the scheduler uses a weighted round robin scheduling scheme.

6. The method of claim 1 wherein the stack processor receives the packet for a scratch ring included in the packet processor.

7. The method of claim 4 wherein the stack processor passes a message through a communication queue to the control processor.

8. A computer program product, tangibly embodied in an information carrier, the computer program product being operable to cause a machine to:
schedule processing of a packet received by a packet processor with a hardware scheduler in a stack processor included in the packet processor.

9. The computer program product of claim 8 wherein instructions to schedule include instructions to receive an interrupt signal from a packet engine included in the packet processor.

10. The computer program product of claim 8 wherein the instructions to schedule include instructions to identify an interrupt handling routine.

11. The computer program product of claim 9 wherein a control processor in the packet processor manages the packet engine.

12. The computer program product of claim 8 wherein instructions to schedule use a weighted round robin scheduling scheme.

13. The computer program product of claim 8 wherein the stack processor receives the packet from a scratch ring included in the packet processor.

14. The computer program product of claim 11 wherein the stack processor passes a message through a communication queue to the control processor.

15. A scheduler comprises:
a process to schedule processing of a packet received by a packet processor with a hardware scheduler in a stack processor included in the packet processor.

16. The scheduler of claim 15 wherein the scheduling includes receiving an interrupt signal from a packet engine included in the packet processor.

17. The scheduler of claim 15 wherein the scheduling includes identifying an interrupt handling routine.

18. A system comprising:
a packet processor capable of,
scheduling processing of a packet received by the packet processor with a hardware scheduler in a stack processor included in the packet processor.

19. The system of claim 18 wherein scheduling includes receiving an interrupt signal from a packet engine included in the packet processor.

20. The system of claim 18 wherein scheduling includes identifying an interrupt handling routine.

21. A packet forwarding device comprising:
an input port for receiving packets;
an output for delivering the received packets; and
a packet processor capable of,
scheduling processing of a packet received by the packet processor with a hardware scheduler in a stack processor included in the packet processor.

22. The packet forwarding device of claim 21 wherein scheduling includes receiving an interrupt signal from a multithreaded packet engine included in the packet processor.

23. The packet forwarding device of claim 21 wherein scheduling includes identifying an interrupt handling routine.

24. A packet processor comprising:
a packet engine for receiving a packet;
a control processor for managing the packet engine; and
a stack processor for scheduling processing of the received packet with a hardware scheduler.

25. The packet processor of claim 24 wherein the stack processor receives an interrupt signal from the packet engine.

26. The packet processor of claim 24 wherein the hardware scheduler identifies an interrupt handling routine.
